(19) United States
(12) Patent Application Publication
(10) Pub. No.: US 2010/0329101 A1
(43) Pub. Date: Dec. 30, 2010

(54) OPTICAL PICKUP DEVICE

(75) Inventors: Yasushi Kobayashi, Osaka (JP); Masatoshi Yajima, Osaka (JP); Tomoaki Tojo, Hyogo (JP); Kenji Matsumura, Hyogo (JP)

Correspondence Address: PEARNE & GORDON LLP, 1801 EAST 9TH STREET, SUITE 1200, CLEVELAND, OH, 44114-3108, US

(73) Assignee: PANASONIC CORPORATION, Osaka (JP)

(21) Appl. No.: 12/819,483

(22) Filed: Jun. 21, 2010

(30) Foreign Application Priority Data
Jun. 24, 2009 (JP) 2009-149455

(51) Int. Cl. G11B 7/135

(52) U.S. Cl. 369/112.23; G9B/7.112

(57) ABSTRACT

A dichroic mirror is a wedge-shaped quadrangular prism whose cross-section is a trapezoid having an upper base d and a lower base d+Δd. The dichroic mirror receives on its top surface parallel light emitted from a collimating lens and reflects, off the top surface, most of the parallel light towards a wavelength plate. Moreover, the dichroic mirror transmits, through the top surface, part of the parallel light to output the part of the parallel light from a bottom surface facing the top surface toward a front monitor. The dichroic mirror has, on the bottom surface thereof, an inclination of an angle φ with respect to the top surface in a direction where a normal vector N of the bottom surface intersects with an xy-plane formed of: an optical axis x of incident light from the collimating lens; and an optical axis y of light emitted towards the wavelength plate.

### BACKGROUND OF THE INVENTION

1. Field of the Invention

The present invention relates to an optical pickup device for controlling light output from a light source.

2. Description of the Background Art

In an optical pickup device used for reading information from a recording layer of an optical disc or writing information to the recording layer of the optical disc, a front monitor is provided for monitoring part of light emitted from a light source to control light output from the light source so that light with appropriate light intensity is incident onto the recording layer of the optical disc.

A technology disclosed in Japanese Laid-Open Patent Publication No. 2004-5944 (Patent Literature 1), for example, is known as a light intensity controller using this front monitor. FIG. 10 is a diagram showing a schematic optical configuration of a conventional optical pickup device 101 disclosed in Patent Literature 1.

The conventional optical pickup device 101 in FIG. 10 includes a light source 111, a collimating lens 113, a dichroic mirror 114, an objective lens 116, a front monitor 117, a detection lens 118, and a photodetector 119. An optical disc 150 is a recording medium which information is written to or read from by the optical pickup device 101.

The light source 111 emits light having a predetermined wavelength. The collimating lens 113 converts diffused light emitted from the light source 111 into parallel light. The dichroic mirror 114 is a wedge-shaped quadrangular prism (trapezoid prism) whose cross-section is a trapezoid having an upper base d and a lower base d+Δd (see FIG. 2B). This dichroic mirror 114 receives on its top surface (a side surface formed of sides other than the upper base and the lower base) the parallel light emitted from the collimating lens 113 to reflect most of the parallel light towards the objective lens 116, and simultaneously, outputs, from a bottom surface facing the top surface, part of the parallel light being transmitted through the top surface towards the front monitor 117. The objective lens 116 focuses the light on the recording layer of the optical disc 150. The front monitor 117 receives the light, which has been transmitted through the dichroic mirror 114, to optimally control light output from the light source. Information light reflected by and coming from the optical disc 150 is received by the photodetector 119 through the detection lens 118.

In general, the front monitor 117 receives two monitoring light beams: light transmitted through the dichroic mirror 114; and internal reflected light reflected off the internal surface of the dichroic mirror 114 twice or more and then outputted. When the transmitted light interferes with the internal reflected light in the front monitor 117, contrast of interference fringes caused by the interference varies depending on the fluctuation in wavelength of light, or the like, and thus an amount of receiving light obtained by the front monitor 117 fluctuates. This results in abnormal control of the light output from the light source, and consequently, a stable amount of light cannot be obtained.

Therefore, in the conventional optical pickup device 101, an angular difference Δθ is provided between the transmitted light and the internal reflected light to reduce the influence of the interference caused by the transmitted light and the internal reflected light in an effective light receiving region (a light receiving section) of the front monitor 117 ((a1) of FIG. 3B). Specifically, the dichroic mirror 114 is designed such that the bottom surface thereof has an inclination of an angle θ with respect to the top surface in a direction where a normal vector N of the bottom surface becomes parallel to an xy-plane formed of: an optical axis x of incident light onto the dichroic mirror 114; and an optical axis y of light emitted from the dichroic mirror 114 (see FIG. 2B).

There has recently been a demand for development of a multimedia optical pickup device that supports all optical discs of BD (Blu-ray Disc) optical systems, DVD (Digital Versatile Disc) optical systems, and CD (Compact Disc) optical systems. The following drawbacks, however, should be considered in achieving the multimedia optical pickup device.

It is well-known that the depth of a recording layer on which information is recorded differs depending on the type of optical discs. Further, there are optical discs in which the recording layer is dual-layered. Therefore, control that uses a mechanism (not shown) which allows the collimating lens 113 to move forward and backward in an optical axis direction is required for focusing light on each of the positions of the respective recording layers of the optical disc 150.

However, as shown in FIG. 11, the collimating lens 113 has a predetermined focal length L to the light source, over which the collimating lens 113 can output the parallel light. If the length is L−ΔL, light outputted by the collimating lens 113 diverges, and if the length is L+ΔL, light outputted by the collimating lens 113 converges.

Accordingly, even if the dichroic mirror 114 has the wedge angle θ, which is designed on an assumption that the parallel light is emitted from the collimating lens 113 as described above, the internal reflected light resulted from the divergent light or the convergent light caused by movement of the collimating lens 113, may become parallel to the transmitted light ((b1) of FIG. 3B), thereby undesirably causing the interference to occur. That is, when the conventional dichroic mirror 114 is used in the multimedia optical pickup device or the like, a problem remains that there is a trade-off between movability of the collimating lens and reduction in influence of the interference in the front monitor.

### SUMMARY OF INVENTION

Accordingly, the object of the present invention is to provide an optical pickup device that achieves both movability of the collimating lens and reduction in influence of the interference of light in the front monitor.

The present invention is directed to an optical pickup device for controlling an amount of light incident onto an optical disc. In order to achieve this object, an optical pickup device of the present invention includes: a light source for emitting light having a wavelength; a collimating lens for converting the light emitted from the light source into one of parallel light, divergent light, and convergent light, according to a focal length; a dichroic mirror for reflecting, off a top surface thereof, part of the light outputted by the collimating lens towards the optical disc, and transmitting remaining light through the top surface and a bottom surface facing the top surface; and a front monitor for detecting the light transmitted through the dichroic mirror to control an amount of the light emitted from the light source, according to a detection result. The dichroic mirror has, on the bottom surface thereof, an inclination of an angle φ with respect to the top surface in a direction where a normal vector of the bottom surface intersects with a plane formed of: an optical axis of incident light from the collimating lens; and an optical axis of light emitted towards the optical disc.

In a case where a plurality of light sources for emitting a plurality of light beams having different wavelengths are used, a plurality of dichroic mirrors may be provided uniquely associating to the respective plurality of light beams. In this case, one of the plurality of dichroic mirrors may have an inclination of the angle φ. Preferably, the angle φ has a value ranging from 0.04 degrees to 0.2 degrees.

Typically, a light source for Blu-ray discs is used. The light source emits light having a blue wavelength suitable for recording on and reproduction from an optical disc of a Blu-ray disc optical system. Moreover, a multimedia optical pickup device can be realized when the light source for the Blu-ray discs is used in conjunction with: a light source for digital versatile discs, which emits light having a red wavelength suitable for recording on and reproduction from an optical disc of a digital versatile disc optical system; and a light source for compact discs, which emits light having an infrared wavelength suitable for recording on and reproduction from an optical disc of a compact disc optical system.

According to the present invention, movability of the collimating lens and reduction in influence of the interference of light in the front monitor, which are conventionally in a trade-off, can both be achieved. Additionally, a stable amount of light can be obtained by controlling light output from the light source.

These and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is a diagram showing a schematic optical configuration of an optical pickup device 1 according to the first embodiment of the present invention.

FIG. 2A is an arrow view and a side view of a dichroic mirror 14 of the present invention.

FIG. 2B is an arrow view and a side view of a conventional dichroic mirror 114.

FIG. 2C is another arrow view and another side view of the dichroic mirror 14 of the present invention.

FIG. 3A is a diagram illustrating examples of optical paths of transmitted light 11a and internal reflected light 11b in the dichroic mirror 14 of the present invention.

FIG. 3B is a diagram illustrating examples of optical paths of transmitted light 111a and internal reflected light 111b in the conventional dichroic mirror 114.

FIG. 4 is a diagram showing correlation of an angular difference Δθ between the transmitted light and the internal reflected light with an amount of light output variation in a light receiving section of a front monitor 17.

FIG. 5 is a diagram showing correlation between a position of a collimating lens 13 and the angular difference Δθ.

FIG. 6 is a diagram showing an example of relation between a wedge angle φ of the dichroic mirror 14 and an angular difference Δφ.

FIG. 7 is a diagram showing correlation between the wedge angle φ of the dichroic mirror 14 and astigmatism of a BD objective lens 16.

FIG. 8 is a diagram showing a schematic optical configuration of an optical pickup device 2 according to the second embodiment of the present invention.

FIG. 9 is a diagram showing another schematic optical configuration of the optical pickup device 2 according to the second embodiment of the present invention.

FIG. 10 is a diagram showing a schematic optical configuration of a conventional optical pickup device 101.

FIG. 11 is a diagram illustrating relation between a focal length L and output light of the collimating lens 113.

### DESCRIPTION OF THE PREFERRED EMBODIMENTS

### First Embodiment

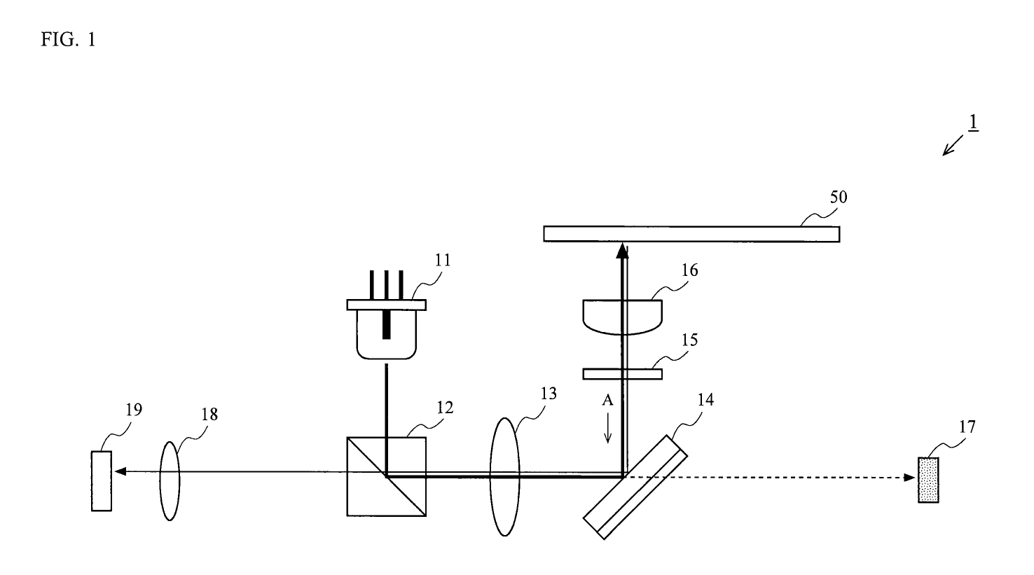

FIG. 1 is a diagram showing a schematic optical configuration of an optical pickup device 1 according to the first embodiment of the present invention. In FIG. 1, the optical pickup device 1 according to the first embodiment includes: a light source 11; a polarizing dichroic prism 12; a collimating lens 13; a dichroic mirror 14; a wavelength plate 15; an objective lens 16; a front monitor 17; a detection lens 18; and a photodetector 19. An optical disc 50 is a recording medium which information is written to or read from by the optical pickup device 1.

The light source 11 is typically a laser light source and emits light having a predetermined wavelength. Specifically, if the optical disc 50 is an optical disc of a BD optical system, the light source 11 emits light having a wavelength in a blue wavelength region (ranges from about 395 nm to 420 nm, preferably, 405 nm). If the optical disc 50 is an optical disc of a DVD optical system, the light source 11 emits light having a wavelength in a red wavelength region (ranges from about 645 nm to 685 nm, preferably, 660 nm). If the optical disc 50 is an optical disc of a CD optical system, the light source 11 emits light having a wavelength in an infrared wavelength region (ranges from about 760 nm to 810 nm, preferably, 780 nm).

The polarizing dichroic prism 12 polarizes and reflects light (diffused light) emitted from the light source 11 towards the collimating lens 13. The collimating lens 13 converts the diffused incident light into parallel light. The collimating lens 13 is provided with a movable mechanism for focusing light on the recording layer of the optical disc 50, which is neither shown nor described herein as it does not constitute a main part of the present invention.

The dichroic mirror 14 is a wedge-shaped quadrangular prism (trapezoid prism) whose cross-section is a trapezoid having an upper base d and a lower base d+Δd. This dichroic mirror 14 receives on its top surface the parallel light emitted from the collimating lens 13 and reflects, off the top surface, most of the parallel light towards the wavelength plate 15. Moreover, the dichroic mirror 14 transmits, through the top surface, part of the parallel light to output the part of the parallel light from a bottom surface facing the top surface toward the front monitor 17.

The wavelength plate 15 converts the parallel light reflected by the dichroic mirror 14 into circularly polarized light. The objective lens 16 focuses the circularly polarized light on the recording layer of the optical disc 50. The front monitor 17 receives the light, which has been transmitted through the dichroic mirror 14, to control light output from the light source 11. Note that, a method of controlling the light output from the light source 11 according to a result of light reception by the front monitor 17 is neither described herein nor shown as it does not constitute a main part of the present invention. Information light reflected by and coming from the optical disc 50 is received by the photodetector 19 through the detection lens 18.

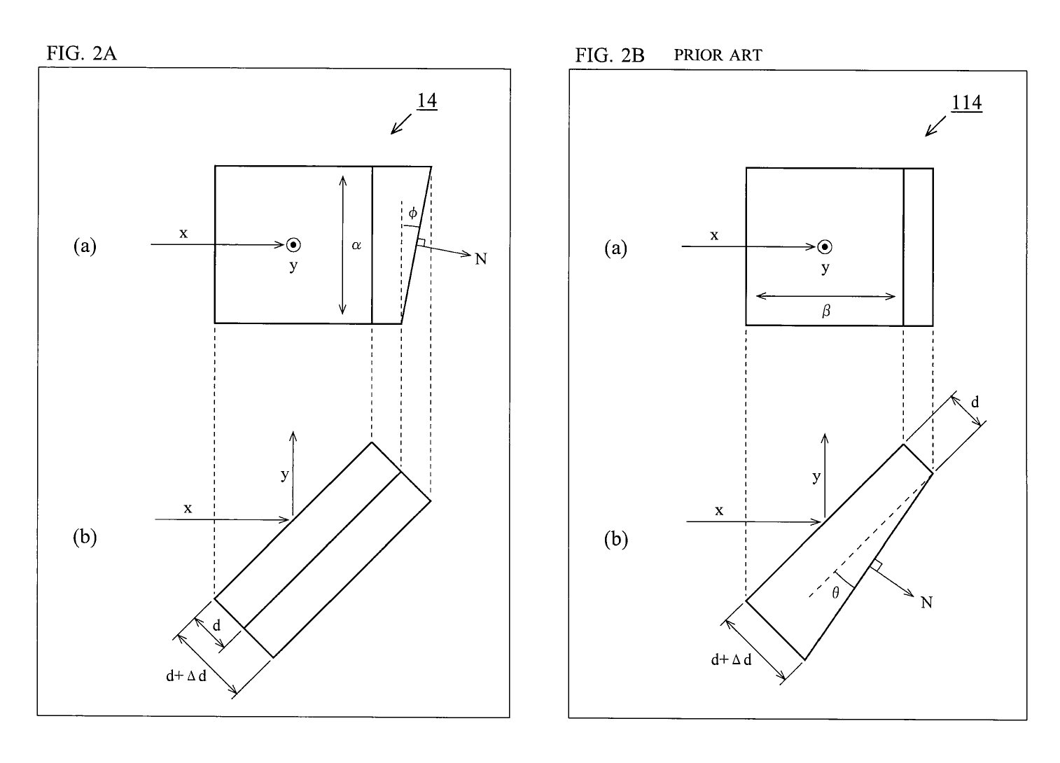

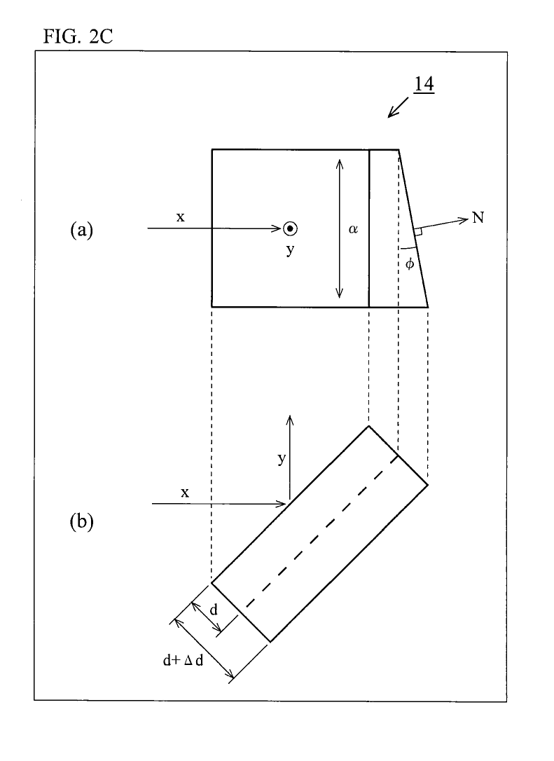

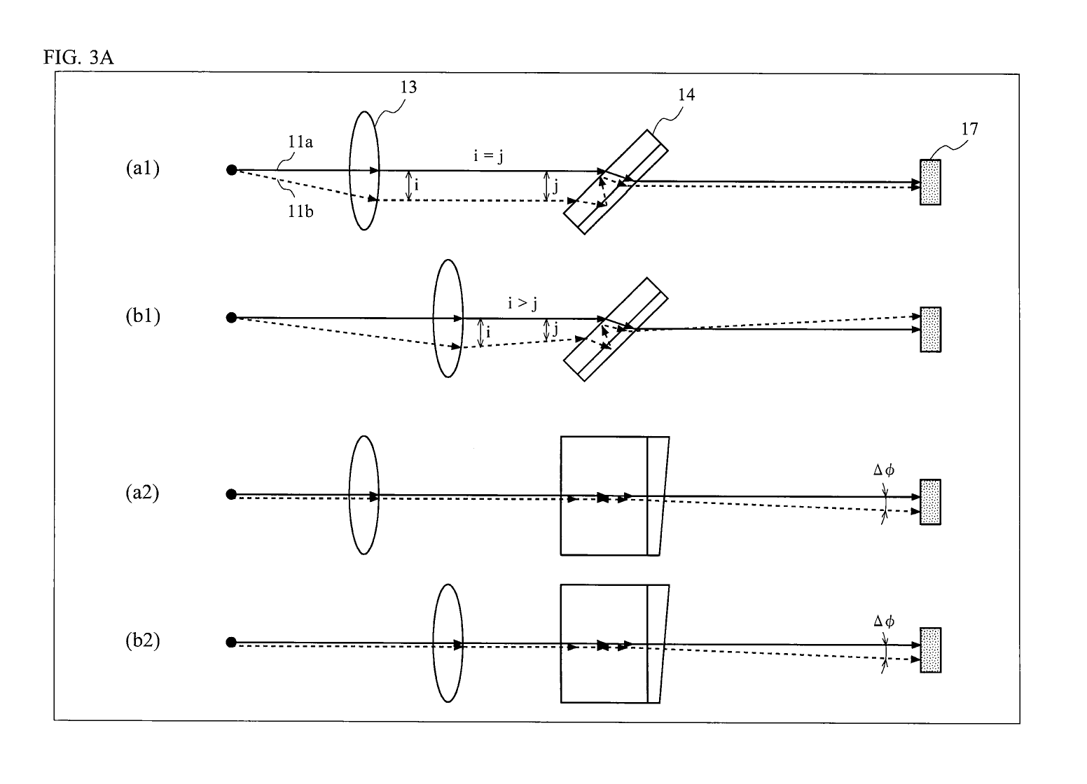

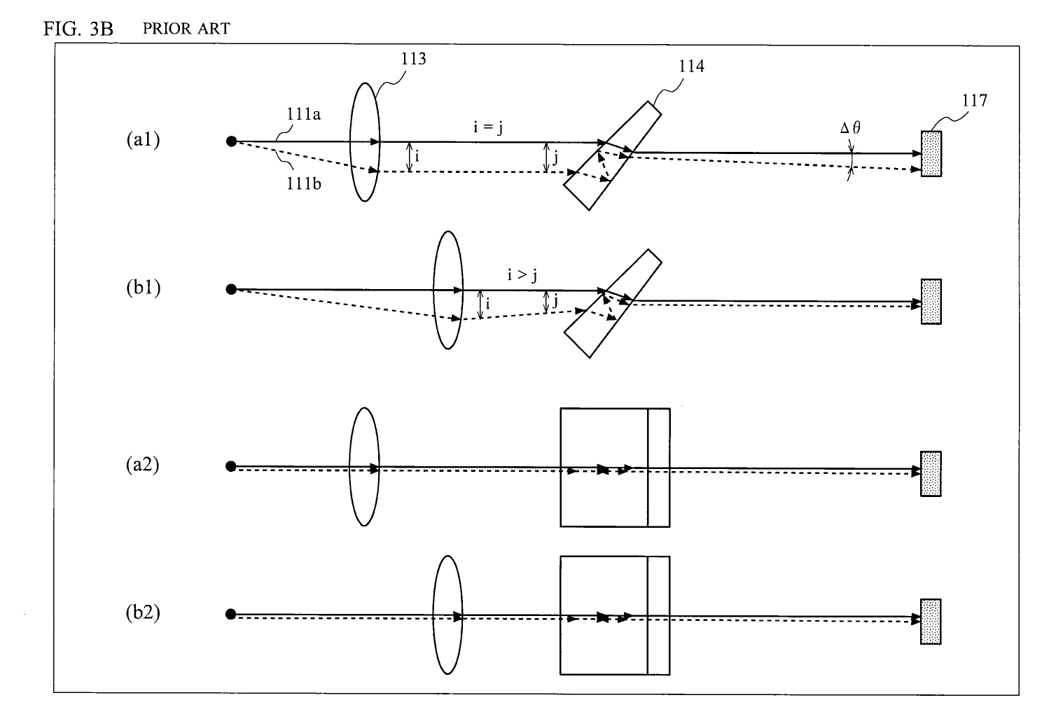

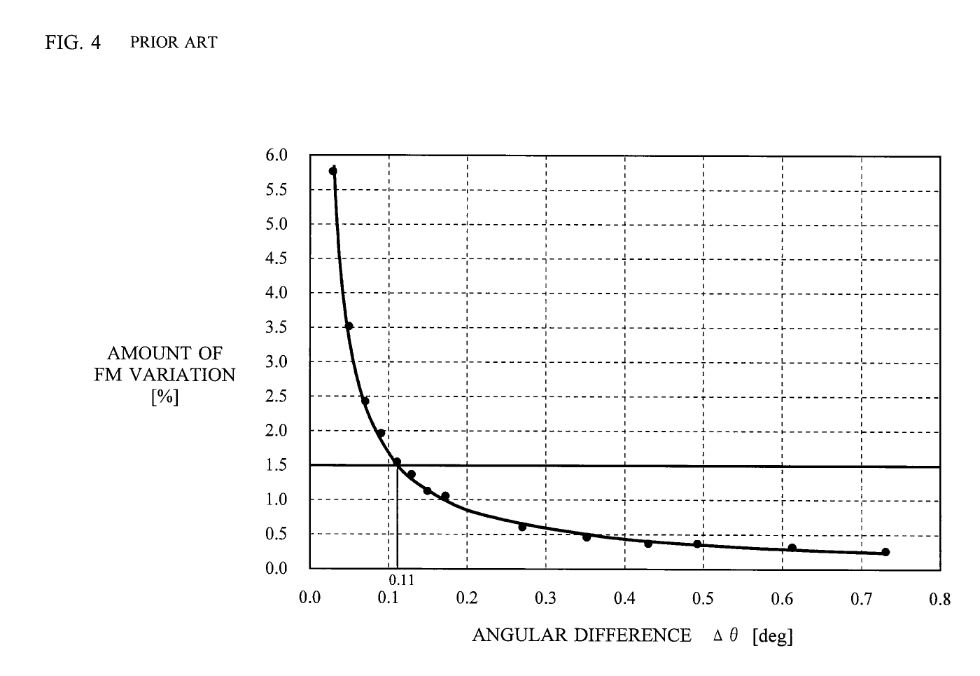

The feature of the present invention is that the direction of an inclination provided on the bottom surface of the dichroic mirror 14 differs from the direction of an inclination provided on the conventional dichroic mirror 114. The following describes in detail this feature, referring further to FIG. 2A, FIG. 2B, FIG. 3A, and FIG. 3B.

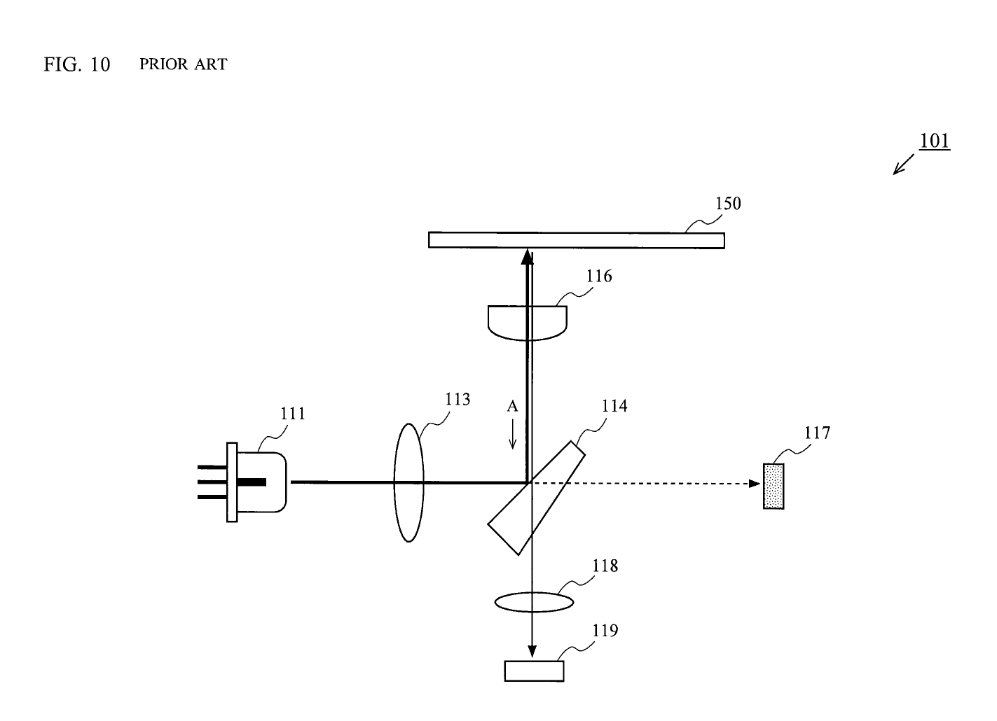

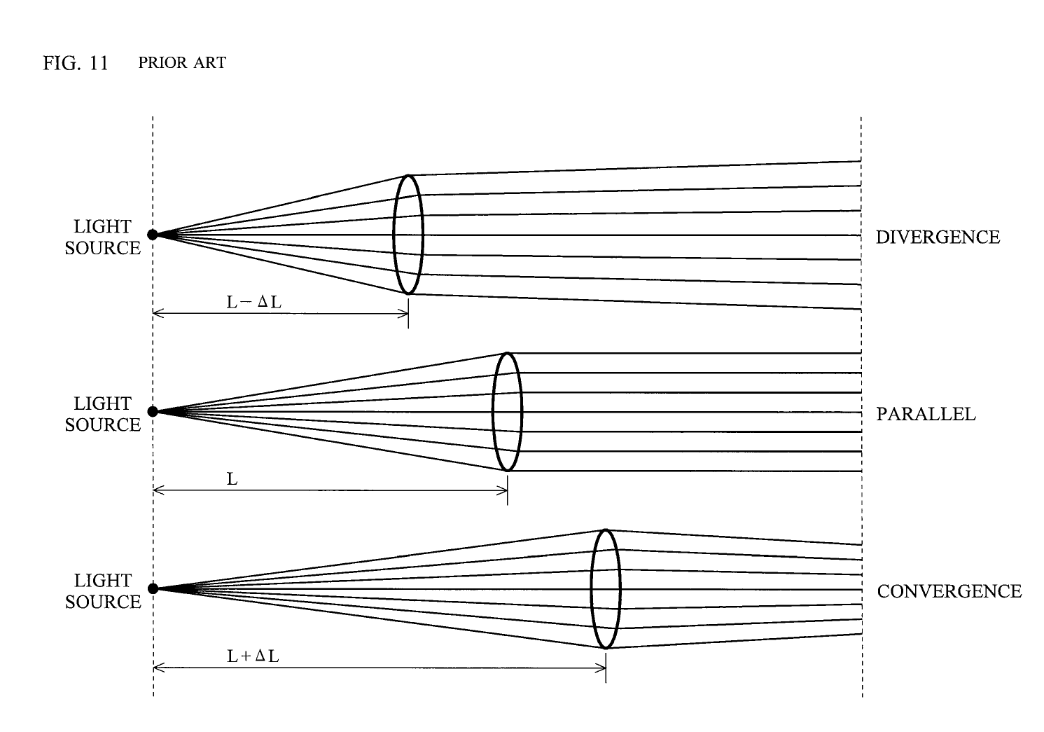

FIG. 2A is a diagram showing the dichroic mirror 14 of the present invention, wherein (a) is an arrow view taken from an A direction in FIG. 1, and (b) is a side view thereof. FIG. 2B is a diagram showing the conventional dichroic mirror 114, wherein (a) is an arrow view taken from an A direction in FIG. 10, and (b) is a side view thereof.

As shown in FIG. 2B, the conventional dichroic mirror 114 is designed such that a bottom surface thereof has an inclination of an angle θ with respect to a top surface thereof in a direction where a normal vector N of the bottom surface becomes parallel to an xy-plane formed of: an optical axis x of incident light from the collimating lens 13; and an optical axis y of light emitted towards the objective lens 116. That is, the dichroic mirror 114 has a wedge angle θ with respect to a direction of light having different optical path lengths between the collimating lens 113 and the dichroic mirror 114 (β direction in FIG. 2B).

In contrast to the conventional dichroic mirror 114, the dichroic mirror 14 of the present invention is designed, as shown in FIG. 2A, such that the bottom surface thereof has an inclination of an angle φ with respect to the top surface thereof in a direction where a normal vector N of the bottom surface intersects with an xy-plane formed of: an optical axis x of incident light from the collimating lens 13; and an optical axis y of light emitted towards the wavelength plate 15. That is, the dichroic mirror 14 has a wedge angle φ with respect to a direction of light having the same optical path length between the collimating lens 13 and the dichroic mirror 14 (α direction in FIG. 2A). Note that the wedge angle φ may be provided in a direction shown in FIG. 2C.

FIG. 3A is a diagram illustrating examples of optical paths of transmitted light 11a and internal reflected light 11b in the dichroic mirror 14 in a configuration where the collimating lens 13 and the front monitor 17 are included in FIG. 2A. FIG. 3B is a diagram illustrating examples of optical paths of transmitted light 111a and internal reflected light 111b in the dichroic mirror 114 in a configuration where the collimating lens 113 and the front monitor 117 are included in FIG. 2B.

As shown in FIG. 3B, in the conventional optical pickup device 101, in a case (a1) where the collimating lens 113 and the dichroic mirror 114 are in such a positional relationship (i=j) that the parallel light from the collimating lens 113 is incident, as it is, onto the dichroic mirror 114, because the bottom surface of the dichroic mirror 114 has the inclination of the angle θ in the β direction, the transmitted light 111a and the internal reflected light 111b, which reach the front monitor 117, have an angular difference Δθ therebetween in a β direction parallel to the xy-plane. Next, in a case (b1) where the collimating lens 113 and the dichroic mirror 114 are in such a positional relationship (i>j) that the collimating lens 113 is moved and thus the internal reflected light 111b converges and is incident onto the dichroic mirror 114, the transmitted light 111a and the internal reflected light 111b, which reach the front monitor 117, no longer have the angular difference Δθ in the β direction parallel to the xy-plane. Of course, in both cases, no angular difference occurs in the α direction, in which there is no inclination, perpendicular to the xy-plane (see (a2) and (b2) of FIG. 3B).

In contrast to the conventional optical pickup device 101, as shown in FIG. 3A, in the optical pickup device 1 of the present invention, in a case (a1) where the collimating lens 13 and the dichroic mirror 14 are in such a positional relationship (i=j) that the parallel light from the collimating lens 13 is incident, as it is, onto the dichroic mirror 14, because the bottom surface of the dichroic mirror 14 has the inclination of the angle φ in the α direction, the transmitted light 11a and the internal reflected light 11b, which reach the front monitor 17, have an angular difference Δθ therebetween in the a direction perpendicular to the xy-plane. Note that, the transmitted light 11a and the internal reflected light 11b do not have the angular difference Δθ in the β direction parallel to the xy-plane. Next, even in a case (b1) where the collimating lens 13 and the dichroic mirror 14 are in such a positional relationship (i>j) that the collimating lens 13 is moved and thus the internal reflected light 11b converges and is incident onto the dichroic mirror 14, the transmitted light 11a and the internal reflected light 11b, which reach the front monitor 17, have the angular difference Δφ in the α direction perpendicular to the xy-plane. Of course, in both cases, some angular difference may occur in the β direction parallel to the xy-plane, along with a change in the situation of the internal reflection (see (a2) and (b2) of FIG. 3A).

Here, the wedge angle φ of the dichroic mirror 14 will be discussed.

Firstly, even in the conventional dichroic mirror 114, in order to reduce the influence of the interference of light in the front monitor 17, the number of the interference fringes, which occur in the front monitor 17, is increased to reduce an amount of light output variation caused by the variation of the contrast of the interference fringes. That is, a method is considered for increasing the wedge angle θ of the conventional dichroic mirror 114 to increase the angular difference Δθ between the transmitted light and the internal reflected light. This method, however, depends on the size of a light receiving section of the front monitor 17 or an internal reflectivity of the conventional dichroic mirror 14, and a result may vary depending on the optical system.

FIG. 4 is a diagram showing correlation of the angular difference Δθ between the transmitted light and the internal reflected light with the amount of light output variation in the light receiving section of the front monitor 17 on an assumption that the light receiving section of the front monitor 17 has a diameter of 0.5 mm and the internal reflectivity of the conventional dichroic mirror 114 is 0.5%. Although the amount of light output variation varies more or less, depending on a system on a disc drive or a target disc medium, an allowable amount of the light output variation (amount of FM variation) caused by the interference is about 1.5%. Therefore, referring to FIG. 4, the angular difference Δθ needs to be 0.11° or greater.

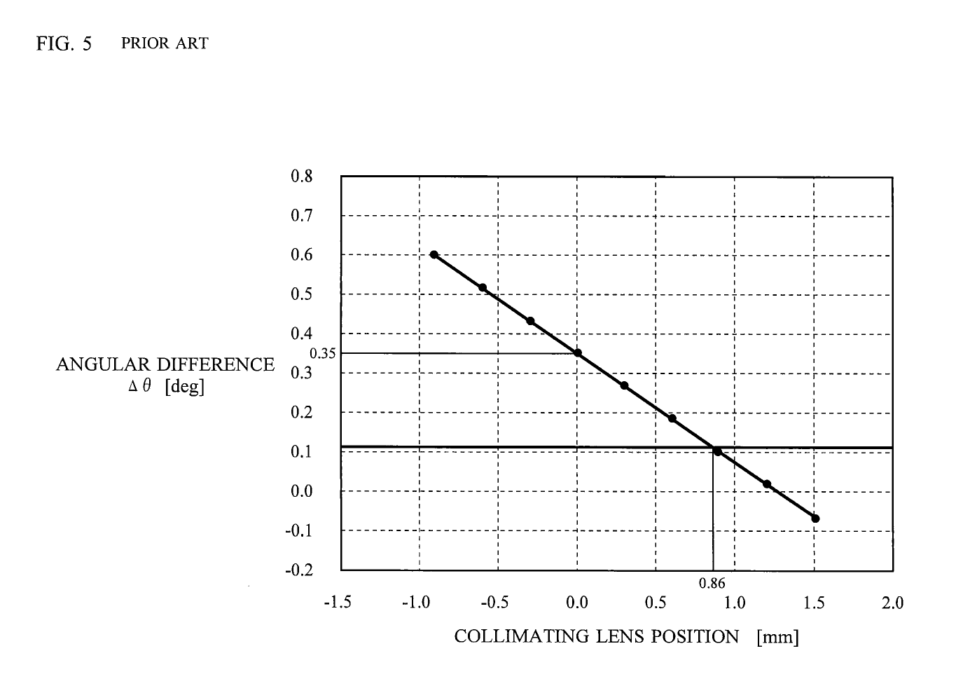

Here, the movement of the collimating lens 13 in a case where the wedge angle θ of the conventional dichroic mirror 114 is 0.1° is considered. FIG. 5 is a diagram showing correlation between the position of the collimating lens 13 and the angular difference Δθ when the focal length L is set to 13 mm. When the collimating lens 13 is located at a center position, the angular difference Δθ becomes 0.35°, and therefore the amount of light output variation is allowable. However, if the collimating lens 13 can be moved by 0.86 mm in a light converging direction, the angular difference Δθ becomes 0.11° or less, and therefore the amount of light output variation exceeds the allowable value. That is, in this case, it is appreciated that the collimating lens 13 needs to be movable in the light converging direction by 0.86 mm or less.

In the case of the DVD optical system, the thickness of base material of the optical disc varies from 0.56 mm to 0.63 mm. Therefore, when the collimating lens 13 is designed to have the focal length L of 13.0 mm, the objective lens 16 is designed to have the focal length L of 2.1 mm, and the optical disc is designed to have the base material thickness of 0.6 mm, the variation in the base material thickness of the optical disc can be absorbed if the collimating lens 13 is movable by 0.9 mm in the light converging direction and by 0.6 mm in the light diverging direction. In other words, in order to absorb the variation, the collimating lens 13 needs to be moved by 0.9 mm in the light converging direction.

As described above, in the direction where the wedged shape is provided on the conventional dichroic mirror 114, there is a trade-off between absorbing the variation by moving the collimating lens 13 and keeping the amount of light output variation in the front monitor 17 within the allowable range, and thus optimal control cannot be performed.

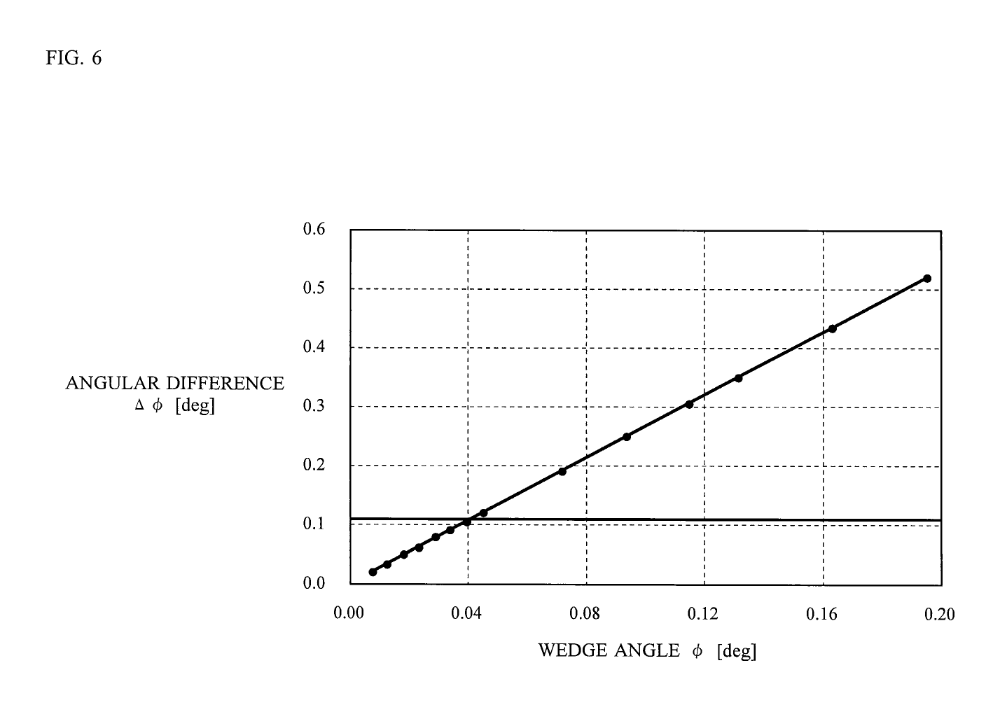

FIG. 6 shows an example of relation between the wedge angle φ of the dichroic mirror 14 of the present invention and the angular difference Δφ between the transmitted light and the internal reflected light. In the example shown in FIG. 6, it is appreciated that, if the wedge angle φ is 0.04° or greater, the angular difference Δφ≧0.11° is secured. That is, if the wedge angle φ is 0.04° or greater, the control of the light output performed by the front monitor 17 can be stabilized in the DVD optical system.

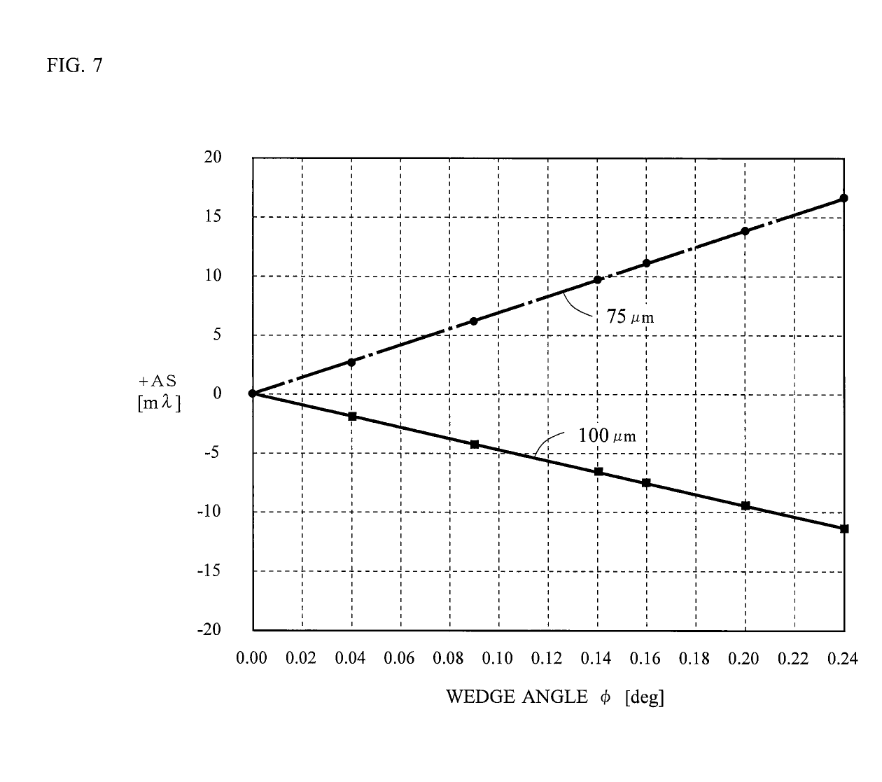

Note that, the upper limit of the wedge angle φ depends on the amount of astigmatism allowable in the BD optical system where advancing light towards the optical disc 50 is transmitted through the dichroic mirror 14. FIG. 7 is a diagram showing correlation between the wedge angle φ of the dichroic mirror 14 and astigmatism (AS) of the BD objective lens 16. In the BD optical system, because there is a dual-layered disc having an L0 layer which has a base material thickness of 100 μm and an L1 layer which has a base material thickness of 75 μm, the objective lens 16 is designed such that the astigmatism becomes zero at a distance of 85 μm which is substantially a midpoint between 75 μm and 100 μm. Therefore, the collimating lens 13 is movable such that light emitted from the collimating lens 13 becomes divergent light when the light is focused on the L0 layer, and becomes convergent light when the light is focused on the L1 layer. Accordingly, because light to be reflected by the dichroic mirror 14 is either the convergent light or the divergent light, astigmatism occurs on the recording layer of the optical disc 50 according to the wedge angle φ, as shown in FIG. 7. Considering astigmatism which occurs due to other optical components or assembling accuracy, the criteria of astigmatism occurring due to the wedge angle φ of the dichroic mirror 14 is ±15 mλ and, preferably, the wedge angle φ is 0.2° or less to satisfy this criteria.

Accordingly, considering, based on the above, the achievement of both the stability of the light output control performed by the front monitor 17 and the suppression of astigmatism, preferably, the wedge angle φ of the dichroic mirror 14 of the present invention is 0.04° or greater and 0.20° or less.

As described above, since the optical pickup device 1 in the first embodiment of the present invention is provided with the dichroic mirror 14 having the inclination of the angle φ in the α direction perpendicular to the xy-plane, the transmitted light and the internal reflected light continuously have the angular difference Δφ in the light receiving section of the front monitor 17. Thus, movability of the collimating lens 13 and reduction in influence of the interference of light in the front monitor 17, which conventionally are in a trade-off, can both be achieved. Additionally, the light output from the light source is controlled, and thus a stable amount of light can be obtained.

### Second Embodiment

In the first embodiment, a light beam of a single wavelength is used for writing information to the optical disc 50 and reading information from the optical disc 50. In the second embodiment, a description is given of an optical pickup device that uses two light beams having different wavelengths. The second embodiment is useful in realizing an optical pickup device that allows the use of, for example, two or more types of optical discs (such as the BD optical system and the DVD optical system).

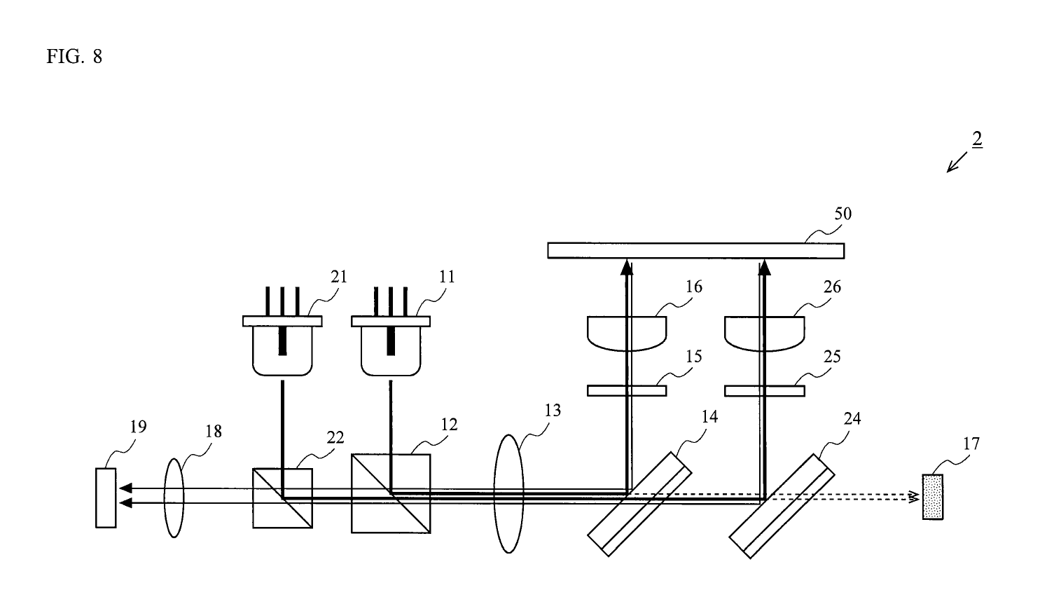

FIG. 8 is a diagram showing a schematic optical configuration of an optical pickup device 2 according to the second embodiment of the present invention. In FIG. 8, the optical pickup device 2 according to the second embodiment includes: a first light source 11; a second light source 21; a first polarizing dichroic prism 12; a second polarizing dichroic prism 22; a collimating lens 13; a first dichroic mirror 14; a second dichroic mirror 24; a first wavelength plate 15; a second wavelength plate 25; a first objective lens 16; a second objective lens 26; a front monitor 17; a detection lens 18; and a photodetector 19. An optical disc 50 is a recording medium which information is written to and read from by the optical pickup device 2.

The optical pickup device 2 is different from the optical pickup device 1 in that the optical pickup device 2 further includes the second light source 21, the second polarizing dichroic prism 22, the second dichroic mirror 24, the second wavelength plate 25, and the second objective lens 26. The description of the optical pickup device 2 is given mainly discussing about these newly added components. Note that, similar reference numerals are given to the components in the optical pickup device 2, which are similar to those in the optical pickup device 1, and the description thereof is omitted.

The first light source 11 emits the first light having a predetermined wavelength λ1. The second light source 21 emits the second light having a predetermined wavelength λ2. The wavelength λ1 is different from the wavelength λ2. The first polarizing dichroic prism 12 polarizes and reflects towards the collimating lens 13 the first light (diffused light) emitted from the first light source 11. Similarly, the second polarizing dichroic prism 22 polarizes and reflects towards the collimating lens 13 the second light (diffused light) emitted from the second light source 21. The first polarizing dichroic prism 12 and the second polarizing dichroic prism 22 are disposed in locations such that the first light and the second light are along a single optical axis.

The first dichroic mirror 14 is a trapezoid prism as described above. The second dichroic mirror 24 is a typical quadrangular prism (a flat plate). The first dichroic mirror 14 receives on its top surface the first light and the second light, which are emitted as parallel light, from the collimating lens 13, and reflects, off the top surface, most of the first light towards the first wavelength plate 15. Moreover, the first dichroic mirror 14 transmits, through the top surface, part of the first light and the entire second light to output the part of the first light and the entire second light from a bottom surface to the second dichroic mirror 24. The second dichroic mirror 24 receives on its top surface the part of the first light and the entire second light which have been transmitted through the first dichroic mirror 14, and reflects off the top surface the most of the second light towards the second wavelength plate 25. Moreover, the second dichroic mirror 24 transmits, through the top surface, the part of the first light and part of the second light (hereinafter referred collectively to as monitoring light) to output the monitoring light from a bottom surface towards the front monitor 17.

The first wavelength plate 15 converts the first light reflected by the first dichroic mirror 14 into circularly polarized light. The second wavelength plate 25 converts the second light reflected by the second dichroic mirror 24 into circularly polarized light. The first objective lens 16 and the second objective lens 26 each focuses the corresponding circularly polarized light on a corresponding recording layer of the optical disc 50.

As described above, according to the optical pickup device 2 in the second embodiment of the present invention, the advantageous effect described in the first embodiment can be obtained even in the configuration where two light beams having different wavelengths are used.

Note that, although, in the second embodiment, the first dichroic mirror 14 which reflects the first light is the characteristic trapezoid prism of the present invention, the second dichroic mirror 24 which reflects the second light may be the characteristic trapezoid prism of the present invention. That is, at least one of the dichroic mirrors disposed on a path where the monitoring light reaches the front monitor 17 may be the characteristic trapezoid prism of the present invention. Employing such a configuration allows the transmitted light and the internal reflected light to continuously have the angular difference Δφ in the light receiving section of the front monitor 17.

Further, although the optical pickup device 2 that uses two light beams having different wavelengths is described in the second embodiment, three or more light beams having different wavelengths may be used. In such a case, the same number of the polarizing dichroic prisms, the dichroic mirrors, the wavelength plates, and the objective lenses as that of the light sources may be included.

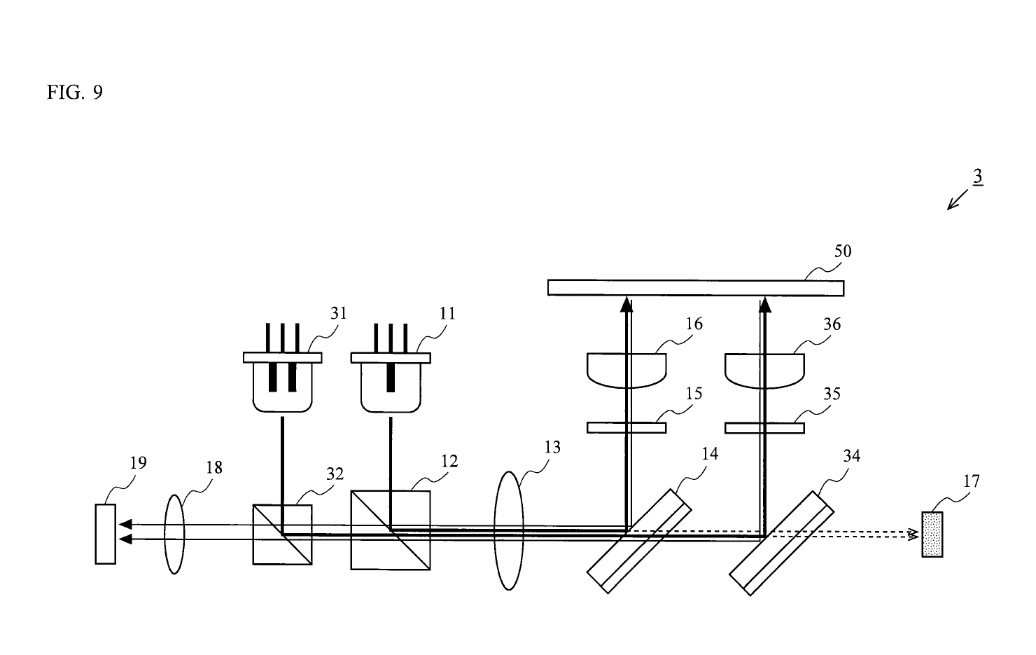

Furthermore, FIG. 9 shows an optical pickup device 3 which uses a light source 31 capable of emitting a plurality of light beams having different wavelengths. In this case, a polarizing dichroic prism 32, a dichroic mirror 34, a wavelength plate 35, and an objective lens 36, which correspond to the respective plurality of light beams having different wavelengths may be included.

### INDUSTRIAL APPLICABILITY

The present invention is applicable to optical pickup devices that controls light output from a light source. The present invention is advantageous, particularly, to achieve both movability of the collimating lens and reduction in influence of the interference of light in the front monitor, and to obtain a stable amount of light by controlling the light output from the light source.

While the invention has been described in detail, the foregoing description is in all aspects illustrative and not restrictive. It is understood that numerous other modifications and variations can be devised without departing from the scope of the invention.

What is claimed is:

1. An optical pickup device for controlling an amount of light incident onto an optical disc, comprising:
a light source for emitting light having a wavelength;
a collimating lens for converting the light emitted from the light source into one of parallel light, divergent light, and convergent light, according to a focal length;
a dichroic mirror for reflecting, off a top surface thereof, part of the light outputted by the collimating lens towards the optical disc, and transmitting remaining light through the top surface and a bottom surface facing the top surface; and
a front monitor for detecting the light transmitted through the dichroic mirror to control an amount of the light emitted from the light source, according to a detection result, wherein
the dichroic mirror has, on the bottom surface thereof, an inclination of an angle φ with respect to the top surface in a direction where a normal vector of the bottom surface intersects with a plane formed of: an optical axis of incident light from the collimating lens; and
an optical axis of light emitted towards the optical disc.

2. The optical pickup device according to claim 1, wherein the light source emits light having a blue wavelength suitable for recording on and reproduction from an optical disc of a Blu-ray disc optical system.

3. The optical pickup device according to claim 1, wherein the angle φ maintained by the dichroic mirror has a value ranging from 0.04 degrees to 0.2 degrees.

4. An optical pickup device for controlling an amount of light incident onto an optical disc, comprising:
a plurality of light sources for emitting a plurality of light beams having different wavelengths, respectively;
a collimating lens for converting the plurality of light beams emitted from the plurality of light sources into one of parallel light, divergent light, and convergent light, according to a focal length;
a plurality of dichroic mirrors provided uniquely associating to the respective plurality of light beams, each dichroic mirror reflecting off its top surface a part of corresponding light among the plurality of light beams outputted by the collimating lens towards the optical disc, and transmitting light other than the part of the corresponding light through the top surface and a bottom surface facing the top surface;
a front monitor for detecting the light beams having been transmitted through the plurality of dichroic minors to control amounts of the plurality of light beams emitted by the plurality of light sources, according to respective detection results, wherein one of the plurality of dichroic mirrors has, on the bottom surface thereof, an inclination of an angle φ with respect to a top surface in a direction where a normal vector of the bottom surface intersects with a plane formed of: an optical axis of incident light from the collimating lens; and an optical axis of light emitted towards the optical disc.

5. The optical pickup device according to claim 4, wherein
one of the plurality of light sources emits light having a blue wavelength suitable for recording on and reproduction from an optical disc of a Blu-ray disc optical system,
another one of the plurality of light sources emits light having a red wavelength suitable for recording on and reproduction from an optical disc of a digital versatile disc optical system, and
still another one of the plurality of light sources emits light having an infrared wavelength suitable for recording on and reproduction from an optical disc of a compact disc optical system.

6. The optical pickup device according to claim 4, wherein the angle φ maintained by one of the dichroic minors has a value ranging from 0.04 degrees to 0.2 degrees.
